(19) United States
(12) Patent Application Publication
(10) Pub. No.: US 2007/0224988 A1
(43) Pub. Date: Sep. 27, 2007

(54) METHOD AND APPARATUS FOR PERFORMING A HANDOVER PROCEDURE BETWEEN A 3GPP LTE NETWORK AND AN ALTERNATIVE WIRELESS NETWORK

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/683,789

(22) Filed: Mar. 8, 2007

Related U.S. Application Data
(60) Provisional application No. 60/785,558, filed on Mar. 24, 2006.

(51) Int. Cl. H04Q 7/20

(52) U.S. Cl. 455/436

(57) ABSTRACT

In a wireless communications system including a third generation partnership project (3GPP) long term evolution (LTE) network, at least one alternative wireless network, and a wireless transmit/receive unit (WTRU), the 3GPP LTE network sends an indication of the availability of the alternative network or a list of available alternative networks in an area where the WTRU is located. The WTRU receives the information and initiates a handover procedure to the alternative wireless network based on the information. The WTRU may request a list of alternative wireless networks from the 3GPP LTE network, or may send capability information to the 3GPP LTE network. The alternative wireless network may be a 3GPP network, an interworking wireless local area network (I-WLAN), or a fixed broadband network.

### CROSS REFERENCE TO RELATED APPLICATION

This application claims the benefit of U.S. Provisional Application No. 60/785,558 filed Mar. 24, 2006, which is incorporated by reference as if fully set forth.

### FIELD OF INVENTION

The present invention is related to wireless communication systems. More particularly, the present invention is related to a method and apparatus for performing a handover procedure between a third generation partnership project (3GPP) long term evolution (LTE) network and an alternative wireless network. The alternative wireless network includes a 3GPP network, an interworking wireless local area network (I-WLAN), a fixed broadband network, or the like.

### BACKGROUND

A plurality of heterogeneous wireless communication networks currently co-exist. Each network uses a different radio access technology (RAT) adapted for the specific services provided by the particular network. 3GPP systems are the dominant types of currently deployed wireless communication systems. LTE is an evolution of the radio interface and the radio network architecture of 3GPP systems. The 3GPP is now considering an LTE of 3GPP systems to provide a new radio access network for higher data rates, lower latency, better packet optimization, improved system capacity, and better coverage.

FIG. 1 shows a proposed architecture of the 3GPP LTE system 100. The 3GPP LTE system 100 includes a global system for mobile communication (GSM) enhanced data rates for GSM evolution (EDGE) radio access network (GERAN) 102, a universal terrestrial radio access network (UTRAN) 104, an evolved radio access network (RAN) 106, an interworking wireless local area network (I-WLAN) 108, a serving global packet radio service (GPRS) support node (SGSN) 110, an evolved packet core 112, a home subscriber server (HSS) 114, and a policy and charging rules function (PCRF) 116. The 3GPP LTE system 100 may also include an IP server 118, (e.g., IP multimedia subsystem (IMS), packet switched streaming (PSS), or the like). In the 3GPP LTE system 100, the evolved RAN 106 and the evolved packet core 112 are added to the conventional 3GPP LTE system 100, and R1, R2, R3, Gx+ and AAA interfaces are newly defined.

Besides the 3GPP and 3GPP LTE networks, non-3GPP systems, (such as fixed broadband systems (FBSs)), have also been proposed and deployed. The non-3GPP systems include WiMAX, (i.e., IEEE 802.16), HIPERMAN, WiBro, or the like.

As a plurality of heterogeneous networks are concurrently deployed, multi-mode wireless transmit/receive units (WTRUs) having at least two radio units to support at least two different RATs have become available. Depending on the capability of the WTRU, the multi-mode WTRU may communicate with two RANs simultaneously and may selectively receive a service through one of the RANs. The multi-mode WTRU may also select a preferred RAN among a plurality of available RANs and may perform a handover from one RAN to another.

Since the 3GPP LTE networks, (including an I-WLAN), and the non-3GPP networks are concurrently deployed, it would be desirable to support a handover between the 3GPP LTE network and the non-3GPP network, or between the 3GPP LTE network and the I-WLAN, for service continuity or a better service experience.

### SUMMARY

The present invention is related to a method and apparatus for performing a handover procedure between a 3GPP LTE network and an alternative wireless network, such as a 3GPP network, an I-WLAN, a fixed broadband network, or the like. The 3GPP LTE network sends an indication of the availability of the alternative network, or a list of available alternative networks in an area where the WTRU is located, to the WTRU. The WTRU receives the information and initiates a handover procedure to the alternative wireless network based on the information. The WTRU may request a list of alternative wireless networks from the 3GPP LTE network or may send capability information to the 3GPP LTE network. The alternative wireless network may be a 3GPP network, an I-WLAN, or a fixed broadband network.

### DESCRIPTION OF THE DRAWINGS

A more detailed understanding of the invention may be had from the following description of a preferred embodiment, given by way of example and to be understood in conjunction with the accompanying drawings wherein:

FIG. 1 shows a 3GPP LTE system architecture;

FIG. 2 is a flow diagram of a process for performing a handover procedure between a 3GPP LTE network and an alternative network in accordance with the present invention;

FIG. 3 is a signaling diagram of an exemplary process for performing a handover procedure between a 3GPP LTE network and an I-WLAN in accordance with the present invention;

FIG. 4 is a signaling diagram of an exemplary process for performing a handover procedure between a 3GPP LTE network and an FBS in accordance with the present invention; and

FIG. 5 is a block diagram of a WTRU configured in accordance with the present invention.

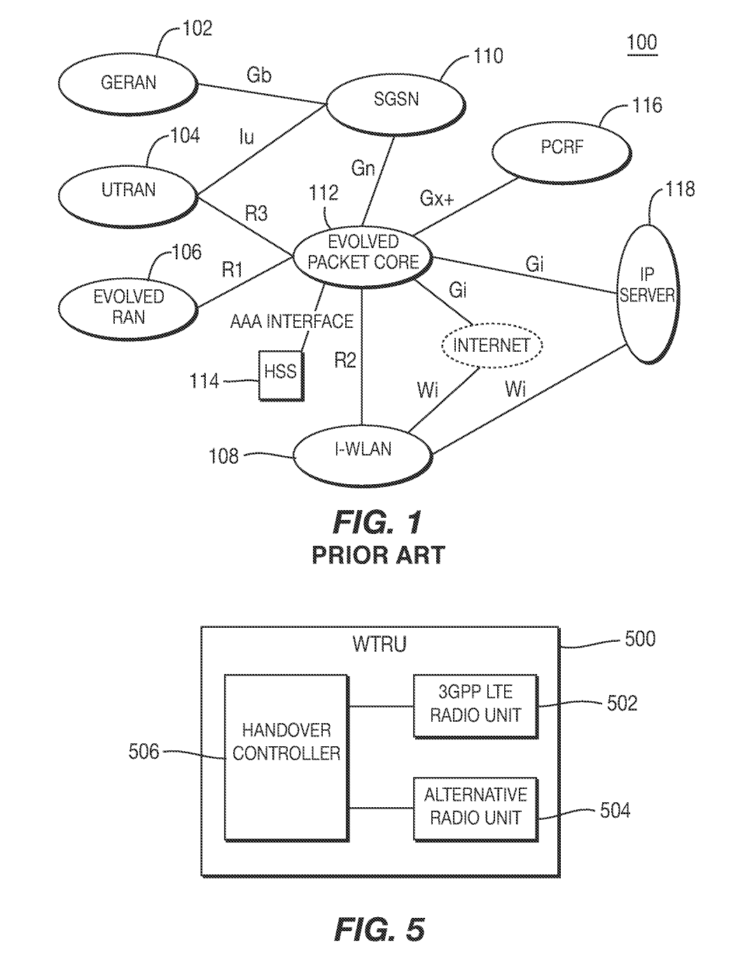

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment.

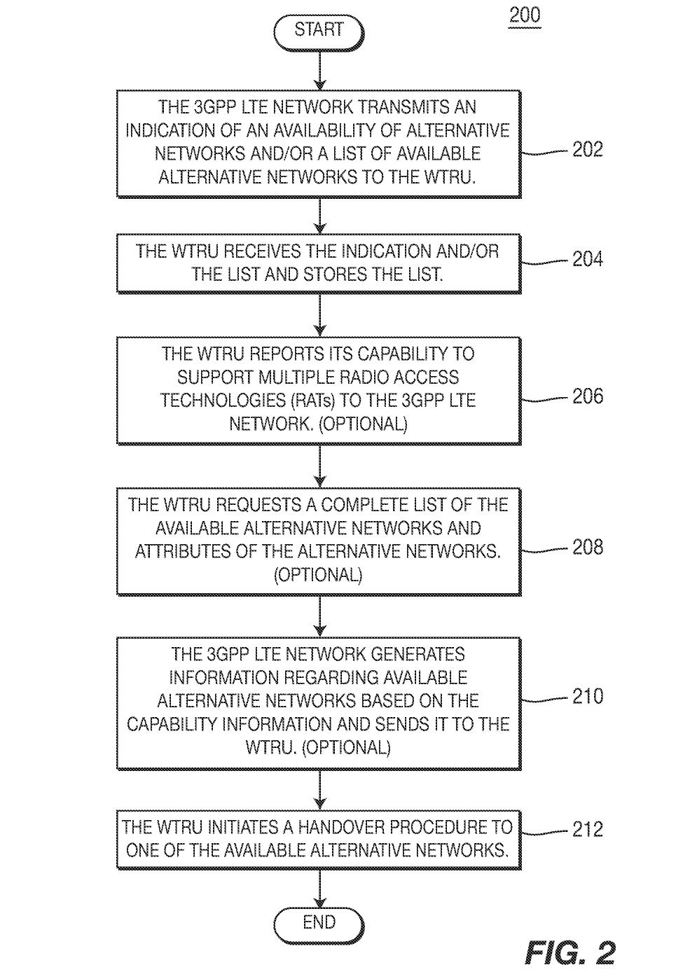

FIG. 2 is a flow diagram of a process 200 for performing a handover procedure between a 3GPP LTE network and an alternative network in accordance with the present invention. The 3GPP LTE network transmits an indication of an availability of alternative networks, (e.g., I-WLAN, non-3GPP networks, or 3GPP networks), and/or a list of available alternative networks to the WTRU (step 202). The 3GPP LTE network may transmit both the indication and the list simultaneously. The 3GPP LTE network may transmit the indication and/or the list by broadcasting, multicasting or unicasting. The 3GPP network includes, but is not limited to, a UTRAN, a GERAN, a GSM network, a GPRS network, or the like.

The WTRU receives the indication and/or the list and stores the list (step 204). Optionally, the WTRU may report its capability to support multiple RATs to the 3GPP LTE network (step 206). If the 3GPP LTE network broadcasts only the indication of the availability of the alternative wireless network, the WTRU may optionally request a complete list of the available alternative networks and attributes of the alternative networks (step 208). Upon receipt of the capability information or the request, the 3GPP LTE network may generate information regarding available alternative networks based on the capability information and send it to the WTRU (step 210). Steps 206-210 are optional.

The WTRU then initiates a handover procedure to one of the available alternative networks (step 212). The WTRU may display the information regarding the alternative networks to the user before initiating a handover procedure. Alternatively, the WTRU may autonomously initiate the handover procedure.

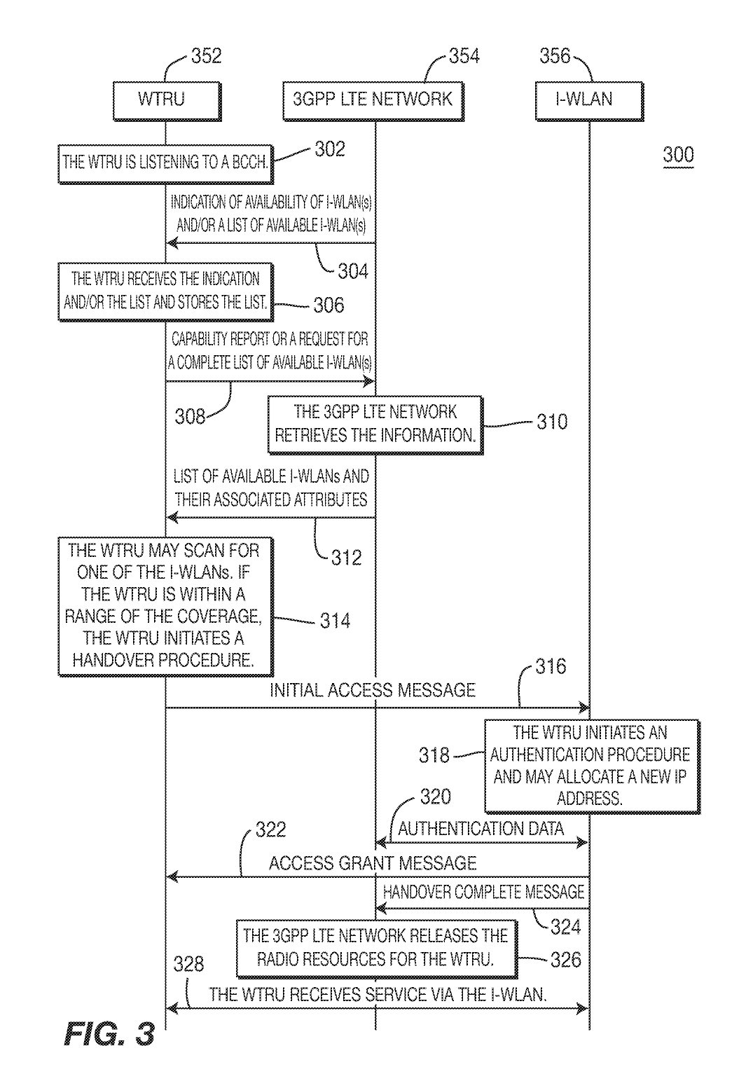

FIG. 3 is a signaling diagram of an exemplary process 300 for performing a handover procedure between a 3GPP LTE network 354 and an I-WLAN 356 in accordance with the present invention. The WTRU 352 listens to the broadcasting, (e.g., a broadcast control channel (BCCH)), from the 3GPP LTE network 354 (step 302). The 3GPP LTE network 354 broadcasts an indication of availability of I-WLAN(s) and/or a list of available I-WLANs in the area on which the WTRU 352 is located (step 304). The WTRU 352 receives the indication and/or the list, and stores the list (step 306).

Steps 308-312 may optionally be performed. If the 3GPP LTE network 354 sends only the indication of available I-WLAN(s), the WTRU 352 may optionally send a capability report indicating I-WLAN capability of the WTRU 352 and/or a request for a complete list of available I-WLANs to the 3GPP LTE network 354 (step 308). In such case, upon receipt of the capability report and/or the request, the 3GPP LTE network 354 retrieves the information of available I-WLANs, (based on the capability report if it is received), (step 310), and sends a list of available I-WLANs and their associated attributes to the WTRU 352 (step 312).

The WTRU 352 may scan, (actively or passively), for one of the I-WLANs and if the WTRU 352 is within a range of a target I-WLAN 356, the WTRU 352 initiates a handover procedure to the target I-WLAN 356 (step 314).

For a handover, the WTRU 352 sends an initial access message to the target I-WLAN 356 (step 316). The target I-WLAN 356 initiates an authentication procedure for the WTRU 352 and may allocate a new IP address to the WTRU 352 depending on the interworking case (step 318). Authentication data is exchanged between the 3GPP LTE network 354 and the target I-WLAN 356 (step 320). Once the WTRU 352 is authenticated, the target I-WLAN 356 sends an access grant message to the WTRU 352 (step 322). The target I-WLAN 356 sends a handover complete message to the 3GPP LTE network 354 (step 324). The 3GPP LTE network 354 releases a radio resource allocated for the WTRU 352 (step 326). The WTRU 352 receives a service via the target I-WLAN 356 (step 328).

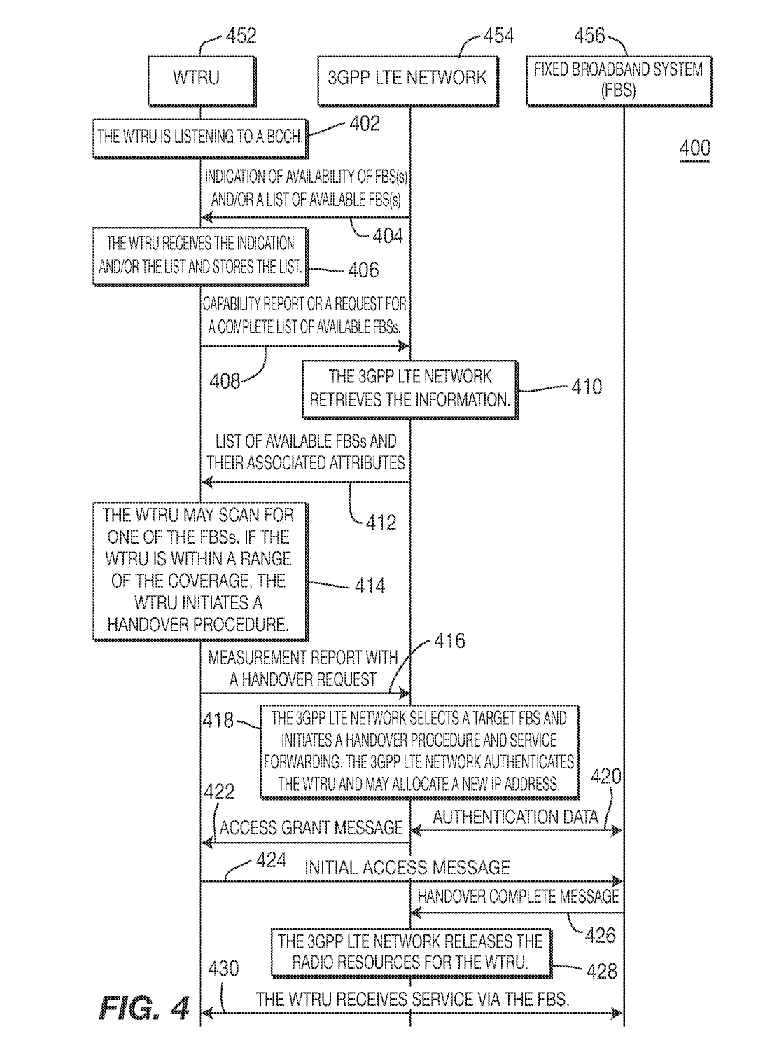

FIG. 4 is a signaling diagram of a process 400 for performing a handover procedure between a 3GPP LTE network 454 and an FBS 456 in accordance with the present invention. The WTRU 452 listens to the broadcasting, (e.g., a BCCH), from the 3GPP LTE network 454 (step 40e). The 3GPP LTE network 454 broadcasts an indication of availability of FBS(s) and/or a list of available FBSs in the area on which a WTRU 452 is located (step 404). The WTRU 454 receives the indication and/or the list, and stores the list (step 406).

Steps 408-412 may optionally be performed. If the 3GPP LTE network 454 sends only the indication of available FBSs, the WTRU 452 may optionally send a capability report indicating FBS capability of the WTRU 452 and/or a request for a complete list of available FBSs to the 3GPP LTE network 454 (step 408). In such case, upon receipt of the capability report and/or the request, the 3GPP LTE network 454 retrieves the information of available FBSs, (based on the capability report if it is received), and their associated attributes and sends them to the WTRU 454 (steps 410, 412).

The WTRU 452 may scan, (actively or passively), for one of the FBSs and if the WTRU 452 is within a range of one of the FBSs, the WTRU 452 initiates a handover procedure (step 414).

The WTRU 452 measures a channel on FBSs and sends a measurement report along with a request for handover to the 3GPP LTE network 454 (step 416). The 3GPP LTE network 454 selects a target FBS 456 based on the measurement report and initiates a handover procedure and service forwarding (step 418). At step 418, the 3GPP LTE network 454 also authenticates the WTRU 452 and may allocate a new IP address to the WTRU 452 depending on the interworking case. Service instantiation and authentication are performed between the 3GPP LTE network 454 and the target FBS 456 (step 420). Once the service is instantiated, the 3GPP LTE network 454 sends an access grant message to the WTRU 452 (step 422). The WTRU 452 then sends an initial access message to the target FBS 456 (step 424). The target FBS 456 sends a handover complete message to the 3GPP LTE network 454 (step 426). The 3GPP LTE network 454 then releases a radio resource allocated for the WTRU 452 (step 428). The WTRU 452 receives a service via the target FBS 456 (step 430).

FIG. 5 is a block diagram of a WTRU 500 configured in accordance with the present invention. The WTRU includes a 3GPP LTE radio unit 502, at least one alternative radio unit 504 and a handover controller 506. The 3GPP LTE radio unit 502 is for communication with the 3GPP LTE network. The alternative radio unit 504 is for communication with an alternative wireless network, such as a 3GPP network or a non-3GPP network. For example, the alternative radio unit 504 may be an I-WLAN radio unit or an FBS radio unit. The 3GPP LTE radio unit 502 receives information regarding the alternative wireless network broadcast by the 3GPP LTE network. The handover controller 506 may initiate a handover to the alternative wireless network based on the information as stated above.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communications system including a third generation partnership project (3GPP) long term evolution (LTE) network, at least one alternative wireless network, and a wireless transmit/receive unit (WTRU), a method for performing a handover procedure between the 3GPP LTE network and the alternative network, the method comprising:
the 3GPP LTE network sending information regarding the alternative wireless network to the WTRU;
the WTRU receiving the information; and
the WTRU initiating a handover procedure to the alternative wireless network based on the information.

2. The method of claim 1 wherein the information is an indication of the availability of the alternative wireless network in an area where the WTRU is located.

3. The method of claim 2 further comprising:
the WTRU requesting a list of alternative wireless networks from the 3GPP LTE network; and
the 3GPP LTE network providing the list of alternative wireless networks to the WTRU, whereby the WTRU initiates the handover procedure to the alternative wireless network based on the list.

4. The method of claim 2 further comprising:
the WTRU sending capability information of the WTRU to the 3GPP LTE network; and
the 3GPP LTE network sending a list of alternative wireless networks to the WTRU based on the capability information, whereby the WTRU initiates the handover procedure to the alternative wireless network based on the list.

5. The method of claim 1 wherein the information is a list of available alternative wireless networks.

6. The method of claim 1 further comprising:
the WTRU displaying the information regarding the alternative wireless network to a user, whereby the handover procedure is initiated upon approval by the user.

7. The method of claim 1 wherein the 3GPP LTE network transmits the information by at least one of broadcasting, multicasting and unicasting.

8. The method of claim 1 wherein the alternative wireless network is an interworking wireless local area network (I-WLAN).

9. The method of claim 8 further comprising:
the WTRU sending an initial access message to the I-WLAN;
the I-WLAN performing an authentication procedure and sending an access grant message if the WTRU is authenticated; and
the WTRU receiving a service from the I-WLAN.

10. The method of claim 9 further comprising:
the I-WLAN allocating a new IP address for the WTRU.

11. The method of claim 1 wherein the alternative wireless network is a fixed broadband network.

12. The method of claim 11 further comprising:
the WTRU performing a measurement on a channel of the fixed broadband network;
the WTRU sending a measurement report to the 3GPP LTE network;
the 3GPP LTE network selecting a target alternative wireless network;
the 3GPP LTE network contacting the target alternative wireless network;
the 3GPP LTE network sending an access grant message to the WTRU if the WTRU is authenticated and an access to the target alternative wireless network is granted;
the WTRU sending an initial access message to the fixed broadband network; and
the WTRU receiving a service from the fixed broadband network.

13. The method of claim 12 further comprising:
the 3GPP LTE network allocating a new Internet protocol (IP) address to the WTRU.

14. The method of claim 1 further comprising:
the WTRU performing a scanning for the alternative wireless network, whereby the WTRU initiates the handover procedure to the alternative wireless network if a predetermined criteria is satisfied after the scanning.

15. The method of claim 14 wherein the WTRU initiates the handover procedure to the alternative wireless network if the WTRU is within a predetermined range of the alternative wireless network.

16. The method of claim 1 further comprising:
the 3GPP LTE network releasing a radio resource for the WTRU after handover to the alternative wireless network is completed.

17. The method of claim 1 wherein the alternative wireless network includes at least one of a universal terrestrial radio access network (UTRAN), a global system for mobile communication (GSM) enhanced data rates for GSM evolution (EDGE) radio access network (GERAN), a GSM network, and a global packet radio services (GPRS) network.

18. A wireless communications system comprising:
at least one alternative wireless network;
a third generation partnership project (3GPP) long term evolution (LTE) network configured to transmit information regarding the alternative wireless network; and
a wireless transmit/receive unit (WTRU) configured to receive the information and initiate a handover procedure to the alternative wireless network based on the information.

19. The system of claim 18 wherein the information is an indication of the availability of the alternative wireless network.

20. The system of claim 19 wherein the WTRU is configured to request a list of alternative wireless networks from the 3GPP LTE network and the 3GPP LTE network is configured to provide the list of alternative wireless networks to the WTRU, whereby the WTRU initiates the handover procedure to the alternative wireless network based on the list.

21. The system of claim 19 wherein the WTRU is configured to send capability information of the WTRU to the 3GPP LTE network and the 3GPP LTE network is configured to send a list of alternative wireless networks to the WTRU based on the capability information, whereby the WTRU initiates the handover procedure to the alternative wireless network based on the list.

22. The system of claim 18 wherein the information is a list of available alternative wireless networks.

23. The system of claim 18 wherein the WTRU is configured to display the information regarding the alternative wireless network to a user and initiate the handover procedure upon approval by the user.

24. The system of claim 18 wherein the 3GPP LTE network is configured to transmit the information by at least one of broadcasting, multicasting and unicasting.

25. The system of claim 18 wherein the alternative wireless network is an interworking wireless local area network (I-WLAN).

26. The system of claim 25 wherein the WTRU is configured to send an initial access message to the I-WLAN to receive a service from the I-WLAN, and the I-WLAN is configured to perform an authentication procedure and send an access grant message if the WTRU is authenticated.

27. The system of claim 26 wherein the I-WLAN is configured to allocate a new IP address for the WTRU.

28. The system of claim 18 wherein the alternative wireless network is a fixed broadband network.

29. The system of claim 28 wherein the WTRU is configured to perform a measurement on a channel of the fixed broadband network, send a measurement report to the 3GPP LTE network, and send an initial access message to the fixed broadband network to receive a service from the fixed broadband network, and the 3GPP LTE network is configured to select a target alternative wireless network based on the measurement report, contact the target alternative wireless network, and send an access grant message to the WTRU if the WTRU is authenticated and an access to the target alternative wireless network is granted.

30. The system of claim 29 wherein the 3GPP LTE network is configured to allocate a new Internet protocol (IP) address to the WTRU.

31. The system of claim 18 wherein the WTRU is configured to perform a scanning for the alternative wireless network, whereby the WTRU initiates the handover procedure to the alternative wireless network if a predetermined criteria is satisfied after the scanning.

32. The system of claim 31 wherein the WTRU initiates the handover procedure to the alternative wireless network if the WTRU is within a predetermined range of the alternative wireless network.

33. The system of claim 18 wherein the 3GPP LTE network is configured to release a radio resource for the WTRU after a handover to the alternative wireless network is completed.

34. The system of claim 18 wherein the alternative wireless network includes at least one of a universal terrestrial radio access network (UTRAN), a global system for mobile communication (GSM) enhanced data rates for GSM evolution (EDGE) radio access network (GERAN), a GSM network, and a global packet radio services (GPRS) network.

35. In a wireless communications system including a third generation partnership project (3GPP) long term evolution (LTE) network and at least one alternative wireless network, a wireless transmit/receive unit (WTRU) configured to perform a handover procedure between the 3GPP LTE network and the alternative wireless network, the WTRU comprising:
a 3GPP LTE radio unit for communication with the 3GPP LTE network, the 3GPP LTE radio unit receiving information regarding the alternative wireless network transmitted by the 3GPP LTE network;
at least one alternative radio unit for communication with the alternative wireless network; and
a handover controller for initiating a handover procedure to the alternative wireless network based on the information.

36. The WTRU of claim 35 wherein the information is an indication of the availability of the alternative wireless network.

37. The WTRU of claim 36 wherein the handover controller is configured to send a request for a list of alternative wireless networks to the 3GPP LTE network, and receive the list from the 3GPP LTE network, whereby the handover controller initiates the handover procedure to the alternative wireless network based on the list.

38. The WTRU of claim 36 wherein the handover controller sends capability information of the WTRU to the 3GPP LTE network, whereby the 3GPP LTE network sends a list of alternative wireless networks to the WTRU based on the capability information.

39. The WTRU of claim 35 wherein the information is a list of available alternative wireless networks.

40. The WTRU of claim 35 wherein the handover controller is configured to display the information regarding the alternative wireless network to a user and initiate the handover procedure upon approval by the user.

41. The WTRU of claim 35 wherein the alternative radio unit is an interworking wireless local area network (I-WLAN) radio unit.

42. The WTRU of claim 35 wherein the alternative radio unit is a fixed broadband system (FBS) radio unit.

43. The WTRU of claim 35 wherein the alternative radio unit performs a scanning for the alternative wireless network, whereby the handover controller initiates the handover procedure to the alternative wireless network if a predetermined criteria is satisfied after the scanning.

44. The WTRU of claim 43 wherein the handover controller initiates the handover procedure to the alternative wireless network if the WTRU is within a predetermined range of the alternative wireless network.
